(19) United States
(12) Patent Application Publication
(10) Pub. No.: US 2005/0266956 A1
(43) Pub. Date: Dec. 1, 2005

(54) Washing machine gearbox

(76) Inventors: Rene Bourquim, Mairinque (BR); Rene Bourquim Galves, Mairinque (BR)

Correspondence Address: SHERIDAN ROSS PC, 1560 BROADWAY, SUITE 1200, DENVER, CO, 80202, US

(21) Appl. No.: 11/118,106

(22) Filed: Apr. 28, 2005

(30) Foreign Application Priority Data
Apr. 29, 2004 (BR) MU8400820

(51) Int. Cl. F16H 37/02

(52) U.S. Cl. 475/331

(57) ABSTRACT

A new and improved washing machine gearbox for interaction with an agitating shaft is provided that possesses greater durability, lightness and uniformity in the transmission of the motive force than gearboxes in the art. Preferably, the gearbox comprises a cylindrical box, preferentially made of high-resistance polymer and equipped in its inner perimeter with an annular gear that meshes with epicycloidal gears formed by a planetary assembly.

This application claims the benefit of Brazilian Utility Model Application Serial No. MU8400820, filed Apr. 29, 2004, which is incorporated by reference in its entirety herein. This application is also related to Brazilian Utility Model Application Serial Nos. MU8400819 and MU8401086, filed Apr. 29, 2004 and May 24, 2004, respectively, which are both incorporated by reference in their entirety herein.

### FIELD OF THE INVENTION

The present invention is an improved mechanical device to be utilized in a common washing machine. More specifically, one embodiment of the present invention utilizes a gearbox coupled to the agitator shaft of a vertical washing machine that is aimed at improving its utilization and performance in relation to other models usually found in the market.

### BACKGROUND OF THE INVENTION

It is widely known that household appliances offer great help in the performance of various domestic chores. With respect to clothes washing, the technical sphere has developed vertical and horizontal machines that include tubs equipped with motor driven shafts that perform balancing and rotational agitating motions to clean and substantially suction water from clothes being cleaned.

The motor driven shafts of the prior art are generally comprised of a cylindrical gearbox, coupled at a top end to a shaft with an outer perimeter coupled to a centrifuging mechanism of the washing machine and an inner shaft that is operably coupled at the bottom to an oscillatory motion mechanism. The oscillatory motion mechanism transmits power to a step down gear assembly enclosed in the cylindrical gearbox. The gear assembly is comprised of a support equipped radially and perpendicularly with shafts coupled to cylindrical gears that mesh with a common center gear. The inner shaft passes through the supporting outer cylindrical shaft and interfaces with the support on one end and the central washing agitator on the other end.

In its ordinary form, the above device works and meets the minimum mechanical performance required by experts and engineers in the field, however, there are also inconveniences related to cost and durability since the cylindrical gears contained in the cylindrical gearbox wear out in time because they work without support such as teeth located on the inner surface of the cylindrical gearbox. This lack of support is due to the impossibility of making a tooth track in the inner perimeter of the cast metal cylindrical box. Further, cylindrical gearboxes are traditionally heavy and indirectly wear out the cylindrical gears arranged in the interior thereof, bringing early losses to the users of washing machines.

Thus, it is a long felt need in the field of washing machines and planetary gear construction to provide a gearing system that is light and easy to construct and resists wear. The following disclosure describes an improved washing machine gear assembly that alters the power transferred from the power source to the agitator of the washing machine, that is preferably constructed of a high resistance polymer that significantly increases the life of the gears and the washing machine in general.

### SUMMARY OF THE INVENTION

One embodiment of the present invention comprises a cylindrical gearbox, preferably made of high-resistance polymer, equipped in its inner perimeter with an annular gear that meshes with epicycloidal gears of a planetary assembly. The planetary assembly comprises a support that is connected to an inner shaft that is connected to the central washing agitator. The inner shaft is also interconnected to four perpendicular shafts that receive four identical planetary gears, whose teeth in an outer tangential plane interface with the teeth of the annular gearing, while the teeth of an inner tangential plane interface with a centralized sun gear that is coupled to an oscillating shaft. The gear proportions of the cylindrical gearbox differ such that the planetary gears of the planetary assembly follow the rotational motion of the sun gear at a lower speed and in the same direction.

It is also an aspect of the present invention to provide a gearbox model for the vertical shafts of washing machines of low cost that combines the requisites of robustness, safety and utilitarian practicality, thus offering the consumer countless possibilities and benefits.

It is yet another aspect of the present invention to provide a new mechanical design of the cylindrical gearbox, being preferably made of high-resistance polymer, so as to enable the application of a set of epicycloidal gears, comprising the sun gear, satellite gears that form a planetary assembly, and the annular gear on the inner perimeter of the cylindrical gearbox. This new constructive arrangement contributes toward a better distribution and transmission of the motive power.

The present invention thus employs a gearbox with desirable mechanical and functional qualities and also has a novel shape, arrangement and location of parts and components that increase the efficiency without any burden whatsoever. The present invention is also designed with the intention of creating a device that is more efficient, longer-lasting, light and that is inexpensive to produce conveniently embodied and arranged to perform its functions with unmatched efficiency and versatility, without the abovementioned inconveniences.

Thus, the present invention provides a practical, innovative gearbox model with all the aesthetic and functional qualities, designed and developed according to the latest methods. One skilled in the art will therefore appreciate that embodiments of the present invention are extremely simple in construction and are quite feasible to build, nevertheless they possess an excellent practical and functional result, with an innovative construction compared to known models.

It is thus one aspect of the present invention to provide a washing machine gearbox comprising:
a gearbox housing that includes an annulus of gears positioned along an inner surface thereof;
a sun gear positioned in the center of said housing;
a plurality of planetary gears that interface with said sun gear and said annulus of gears of said gearbox, each said planetary gear being rotatable about a shaft that is interconnected to a support; and
a shaft interconnected to said support wherein rotation of said sun gear imparts rotation of said plurality of planetary gears wherein said support also rotates to impart rotation on said shaft.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a top perspective view of a gearbox of one embodiment of the present invention;

FIG. 2 is a bottom perspective view of the gearbox shown in FIG. 1;

FIG. 3 is an exploded perspective view of the gearbox shown in FIG. 1;

FIG. 4 is a front elevation view of the gearbox shown in FIG. 1;

FIG. 5 is a top view of the gearbox shown in FIG. 1;

FIG. 6 is a front cross-sectional view of the gearbox shown in FIG. 1;

FIG. 7 is a perspective view of a lower segment of the gearbox showing an annular ring of gear teeth and a sun gear;

FIG. 8 is a perspective view of the lower portion of the gearbox similar to that shown in FIG. 7 that also shows a secondary shaft interconnected to a support that is rotatedly interconnected to a plurality of planetary gears; and

FIG. 9 is a lateral cross-section view of a generic washing machine that utilizes one embodiment of the present invention.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

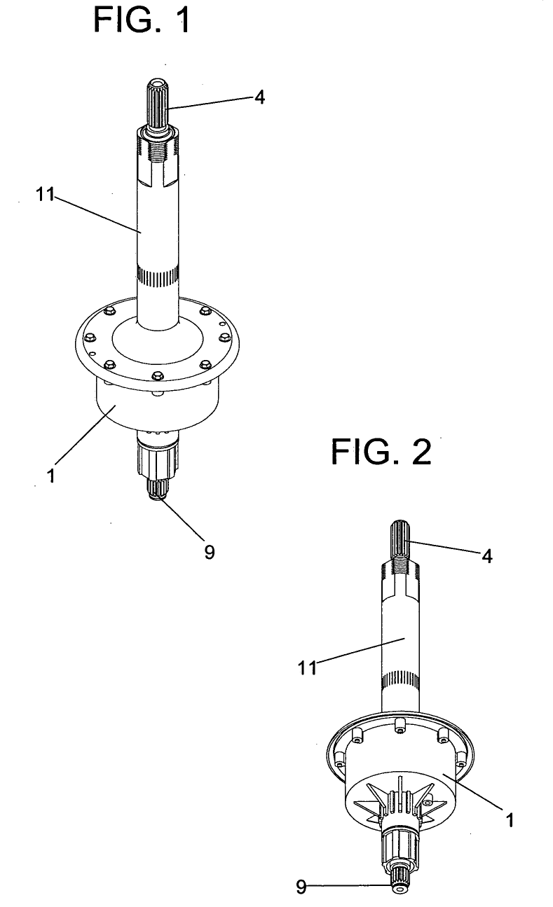

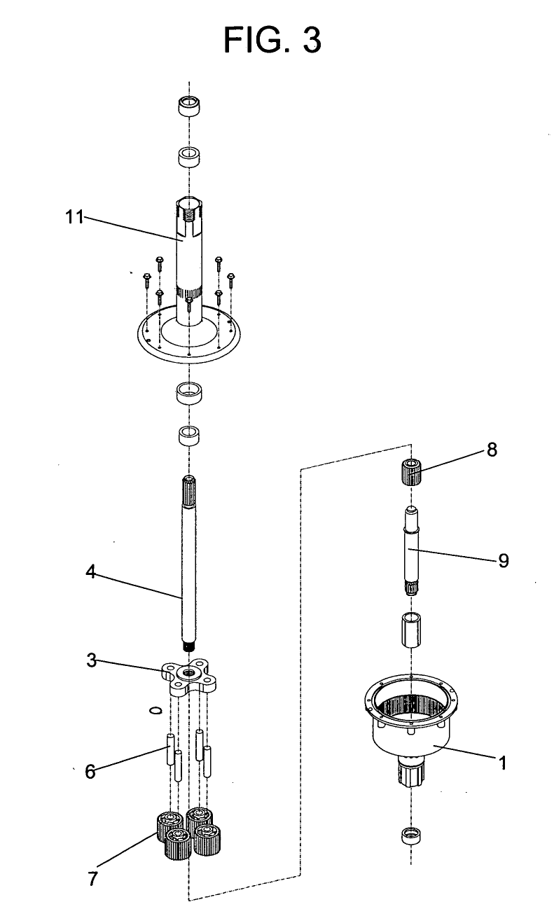

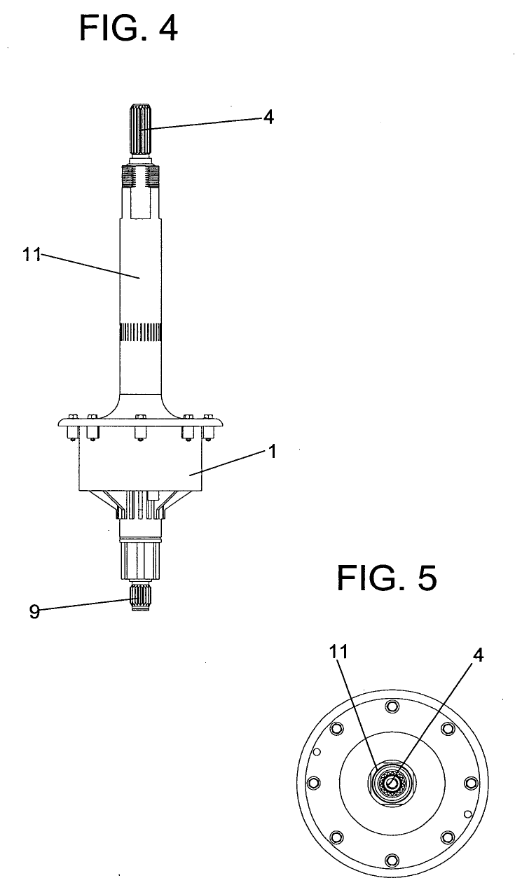

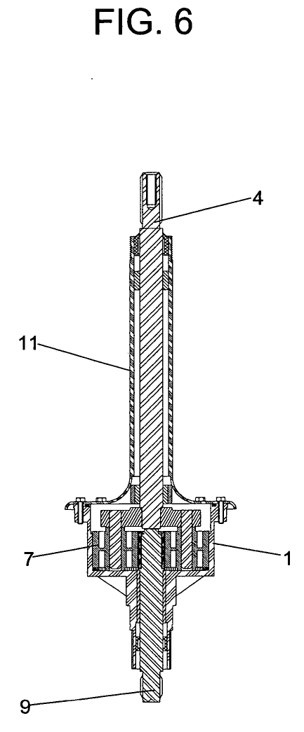

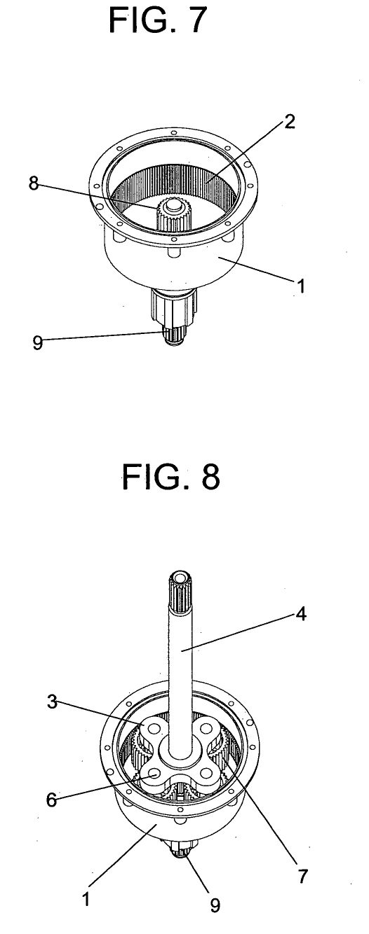

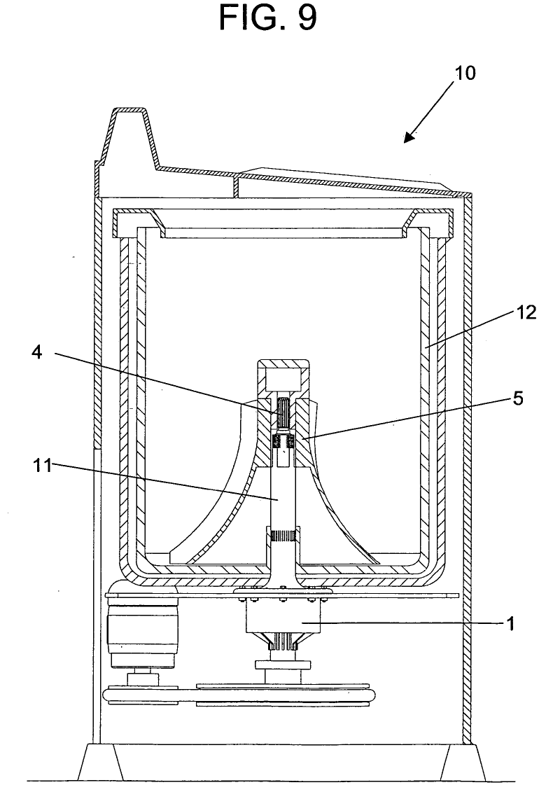

Referring now to FIGS. 1-9, a washing machine gearbox 1 is shown that is preferably made of a high-resistance polymer, and which is equipped in its inner perimeter with an annular gear 2 that meshes with four planetarily arranged epicycloidal gears 7, that are rotatably interconnected to a support 3 via four perpendicular shafts 6. The support 3 is in turn connected to a secondary shaft 4 that is connected to a central washing agitator 5. The teeth of the gears 7 interface with those of the annular ring 2, and the teeth of a sun gear 8. The sun gear 8 is coupled to the end of the shaft 9 that projects through a central part of the cylindrical box 1 and is oscillated by a transmission assembly of the washing machine 10. The gear proportions are customized such that the planetary gears 7 pertaining to the planetary assembly follow the rotational motion of the sun gear 8 at a lower speed and in the same direction. The cylindrical gearbox 1, together with an outer shaft 11, is coupled to the perimeter of the centrifuging mechanism and to the tub 12.

One can therefore see through review of the above figures that the washing machine gearbox 1 of the present invention is characterized as a mechanical component of great utility and innovation, having, as will be seen from an analysis made from the figures shown, countless differences in relation to the conventional models in the consumer market, besides constructive and functional technical features completely different from those belonging to prior art.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

1. A washing machine gearbox, comprising:
a gearbox housing that includes an annulus of gears positioned along an inner surface thereof;
a sun gear positioned in the center of said housing;
a plurality of planetary gears that interface with said sun gear and said annulus of gears of said gearbox, each said planetary gear being rotatable about a shaft that is interconnected to a support; and
a shaft interconnected to said support wherein rotation of said sun gear imparts rotation of said plurality of planetary gears wherein said support also rotates to impart rotation on said shaft.
